(19) United States
(12) Patent Application Publication
(10) Pub. No.: US 2010/0308181 A1
(43) Pub. Date: Dec. 9, 2010

(54) PIPE SUPPORT BASE

(75) Inventors: Masatoshi Azuma, Tokyo (JP); Atsushi Hikoyama, Tokyo (JP)

Correspondence Address: APEX JURIS, PLLC, 12733 LAKE CITY WAY NORTHEAST, SEATTLE, WA, 98125, US

(73) Assignee: ADVANCE CO., LTD., Tokyo (JP)

(21) Appl. No.: 12/814,110

(22) Filed: Jun. 11, 2010

Related U.S. Application Data
(63) Continuation-in-part of application No. 12/507,606, filed on Jul. 22, 2009.

(30) Foreign Application Priority Data
Mar. 12, 2009 (JP) 2009-5526
Mar. 12, 2009 (JP) 2009-5527

(51) Int. Cl. F16L 3/08

(52) U.S. Cl. 248/49

(57) ABSTRACT

To provide a pipe support base with good workability which has the solid body, the channel groove formed on one of four side longitudinal surfaces of the solid body, and the engagement member fitting over the surface of the channel groove and designed to function as the rail for the pipe fastener to slide along the channel groove.

### CROSS-REFERENCE TO RELATED APPLICATION(S)

This is a continuation in part application of U.S. patent application Ser. No. 12/507,606 filed on Jul. 22, 2009, which claimed the benefit under 35 U.S.C. section 119(a) of Japanese Design Applications filed in the Japan Patent Office on Mar. 12, 2007 and assigned serial number 2009-5526 and the Japan Patent Office on Mar. 12, 2007 and assigned serial number 2009-5527, the disclosures of which are incorporated herein by reference.

### FIELD OF INVENTION

This invention relates to a mounting for supporting various types of piping installed on building roofs or the like.

### BACKGROUND OF THE INVENTION

Water supply tanks are normally arranged with cooling-heating devices on building roofs. In order to supply water and/or gas to the inside of a building from such tanks and devices, piping must be installed upon the roofs of these buildings.

This piping is lifted a specific distance from the surface of a roof and is not fixed directly to the roof out of consideration for waterproofing. As such, structures have generally been used in which piping is supported by wood blocks, concrete blocks, or steel columns serving as a mounting.

The above-cited conventional pipe support base has the following problems.

(1) Structures in which piping is fixed to wood blocks are both inexpensive and easy to set up. However, wind, rain, and sunlight cause the wood to corrode and the bolts to be lost, thereby potentially causing the piping to lose its fixture to the wooden base.

(2) With methods for producing mountings by mixing concrete and filling the interior of mold forms with that concrete, mountings which conform to actual conditions can be installed, but such methods take much time and effort.

(3) There are also certain methods in which pipe mountings are constructed together with roof waterproofing as a single unit. With such methods, renovation of roof waterproofing requires cumbersome work such as spreading out sheets of material and covering the periphery of the mounting and, further, this waterproofing may be incomplete as a result.

[Patent Document 1] Japanese Unexamined Patent Application No. 2002-130539.

### SUMMARY OF THE INVENTION

In order to solve the above-described problems, the pipe support base of the present invention is a pipe support base that is a solid body which has at least one channel groove and an engagement member to support a pipe fastener which capture a pipe. The channel groove can be formed on any of four side longitudinal surfaces of the solid body and should be extending in the longitudinal direction of the support base. The engagement member is a separate piece basically covers the surface of the channel groove for better and stable capture and sliding of the pipe fastener which also increases the durability. The engagement member fits over the surface of the channel groove and designed to be a rail in which a bottom part of the pipe fastener can slide therealong.

The solid body can be made of various material as long as it maintains the stability, functionality, and durability. The following embodiments employ a solid concrete block or a solid plastic block.

The engagement member also can be made of various material. A typical example is a metal plate which is deformed to fit over the channel groove reserving a slot for the pipe fastener to slide through. The engagement member can be substituted by a plastic material in the same form. Alternatively, the channel groove itself can function as the engagement member without an additional member.

The engagement member can be mechanically arranged to be adjustable for different types of pipe fasteners.

### BRIEF DESCRIPTION OF THE DRAWINGS

The above and other objects of the present invention will become readily apparent by reference to the following detailed description when considered in conjunction with the accompanying drawings wherein:

FIG. 1 is an explanatory view of the pipe support base of the present invention;

FIG. 2 is a cross section view of the pipe support base of the present invention;

FIG. 3 is an explanatory view of the pipe support base with the pipe fastener and pipe;

FIG. 4 is an explanatory view of the engagement section between the pipe fastener and the engagement member;

FIG. 5 is an explanatory view of the engagement section with different arrangement; and

FIG. 6 is a cross section view of the pipe support base of FIG. 5.

### DETAILED DESCRIPTION OF THE PREFERRED EMBODIMENT

### First Embodiment

The preferred embodiments of the present invention will hereafter be explained in reference to the drawings.

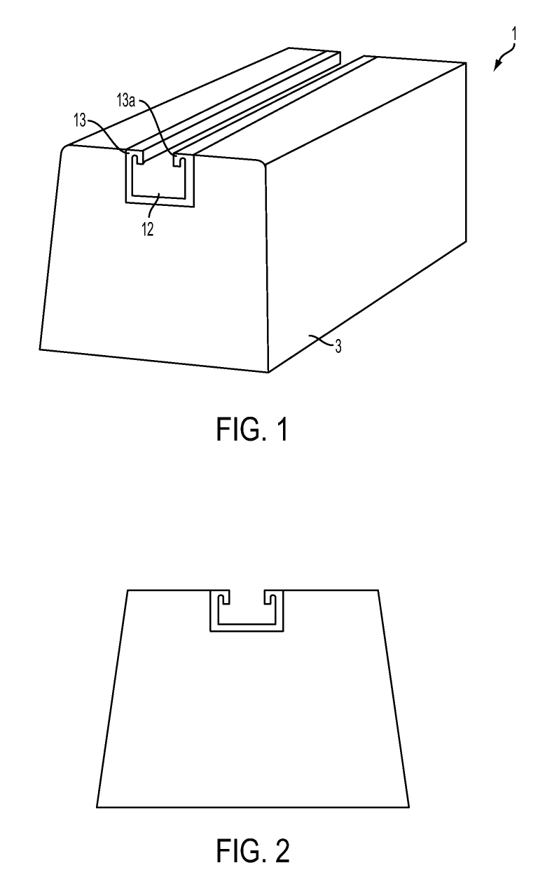

The structure of support 1 will first be explained with reference to FIGS. 1-3. FIG. 1 is an explanatory perspective view of the pipe support base of the present invention, and FIG. 2 is a cross section view of FIG. 1. The basic shape of pipe support base 1 is a solid block, which can be a simple square or trapezoid in cross-section, which is designed to support a pipe P generally on top of a body 3.

A channel groove 12 is formed on any side surfaces of the rectangular body 3 constituting the pipe support base 1. Typically, the channel groove 12 is positioned on a top surface of the body 3. The channel groove 12 is designed to be in the middle of the upper side surface and extending in the longitudinal direction of the support block. Both end of the channel groove 12 are open for the pipe fastener to be inserted or removed therefrom.

An engagement member 13 can be a metal plate fitting over almost entire surface of the channel groove 12. The engagement member 13 has engagement sleeves 13a, 13a, which are projecting in an eave shape toward the inside the cross section of the engagement member 13. Each engagement sleeve 13a is positioned on both edges of the engagement member 13. The engagement sleeve 13a is used to engage and retain the pipe faster 2 for the installation.

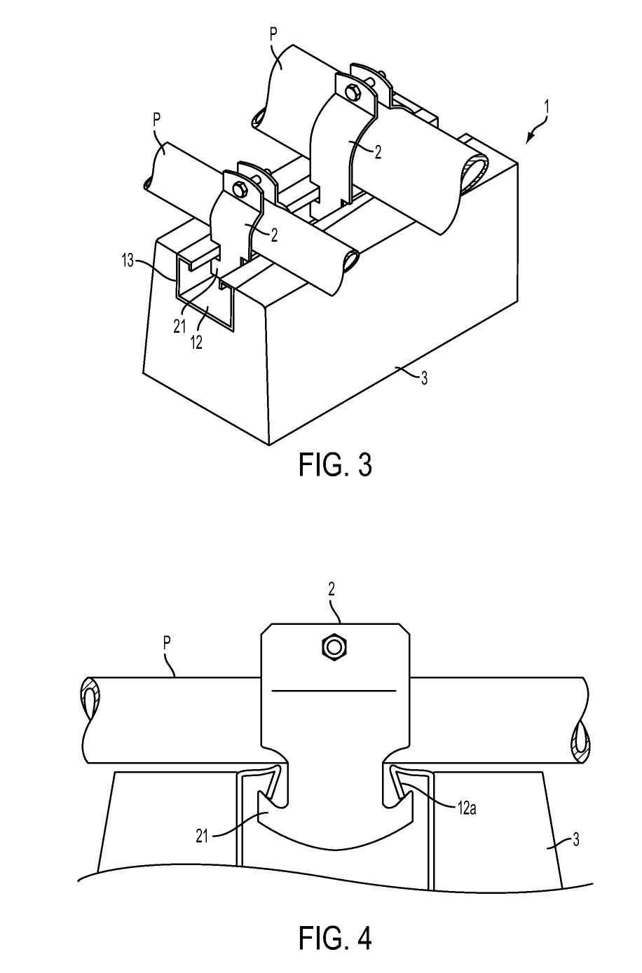

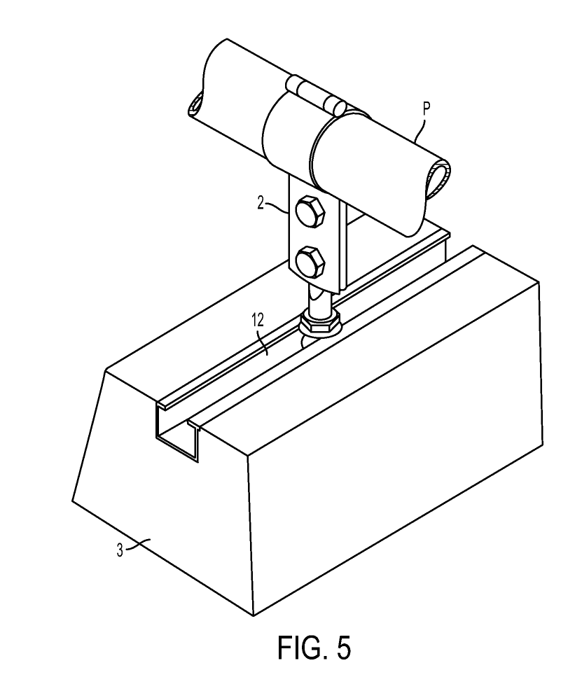

FIG. 4 illustrates the pipe support base of this embodiment with a pipe A installed via a pipe fastener 2. The pipe P is fastened to support base 1 of the present invention by means of the pipe fastener 2. This pipe fastener 2 is a product which is already available commercially and is typically constituted by a combination of two semicircular plates. As shown in FIG. 3, the semicircular plates are rectangular thin plates partially formed with curved portions. Then, when these two semicircular plates are combined to sandwich pipe P, the curved portions thereof are brought into contact with the upper portion of pipe P. When these two semicircular plates are in the combined position, the portions of the semicircular plates above the curved portions are brought closer together than the portions below the curved portions and these proximal portions are fastened together by a bolt placed through these two proximal portions.

The cross-sectional width of channel groove 12 is consistent with the dimensions of commercially-available pipe fastener 2. In the case that pipe fastener 2 is a semicircular plate with certain specification, the width of the portion above its curved portion is constituted to be wider than the width of channel groove 12. The width of the portion below the curved portion is constituted to be narrower than the width of channel groove 12. The lowermost part is formed with a part expanding toward the side surface, the upper end of both ends of this expanding part protruding upwards to form hooks 21. These hooks 21 engage with the inside of engagement sleeve 13a which protrudes inwardly from both sides of channel groove 12. FIG. 4 illustrates bottom portions of the pipe fastener are in arc-shape with each edge of the hooks 21 slightly going up. When the engagement member 12 is made of plastic or thin metal, the edges of the hook 21 lift the ends of the hook 21 to fix the position as the pipe fastener 2 constantly pressurizing the engagement member 13.

### Second Embodiment

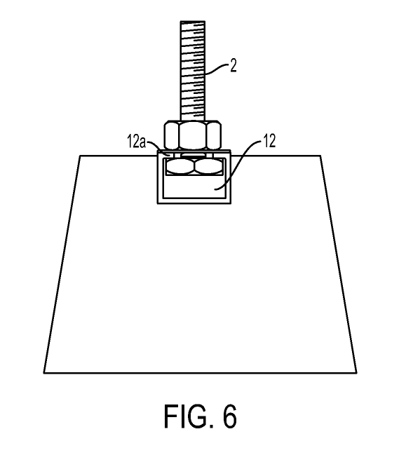

FIGS. 5 and 6 illustrate the second embodiment of the present invention with a bottom bolt type pipe fastener. All elements and features except for the engagement member 13 are same as the first embodiment, and the explanation of which will be omitted.

In the case that pipe fastener 2 is a bolt, the width of channel groove 12 is constituted to be approximately equal to the width of a bolt head part with certain specifications. As such, when the bolt head part is slid from the open side of channel groove 12 to the interior thereof, this bolt head part will be restrained by both wall surfaces of both sides of engagement member 13, thus preventing rotation.

As is described above, there is the engagement sleeve 13a protruding like an eave of a roof into the cross section of groove 12 formed in the longitudinal direction of the support base 1. In the case that this engagement sleeve 13a is, in particular, an L-shaped cross section, a hook 21 of the pipe fastener 2 will push up engagement sleeve 13a from below when the bolt of pipe fastener 2 installing pipe P is tightened. Then, if the cross section of support base 1 is formed by a relatively thin synthetic resin or a thin steel plate, the tightening of engagement member 13 exerts deformation in that hook 21 is pushed upwards. As a result, the end face of engagement member 13 supports the pipe P is supported in a line from beneath pipe P. As such, the pipe P and the support base 1 are brought into contact in such that they are slightly biting into one another by means of the end face of engagement plate 12a, thus maintaining a strong fixture.

### Other Modifications

By making the widths of the plurality of channel grooves 13 formed on support base 1 of the present invention consistent with the specifications of various types of bolt head parts, the pipe P can be fixed through the use of various types of bolts. On the other hand, by making one of the plurality of channel grooves 12 consistent with the specifications of a semicircular plate and then making another channel groove 12 consistent with the specification of a bolt, a plurality of pipe fasteners 2 can be installed with a single support base 1.

The material of the pipe support base can be concrete when a heavy weight base is desirable. The material can also be a lightweight material constituted of plastic or synthetic such as ABS resin or AES resin. The engagement member 13 can be a metal plate or plastic plate fitting over the channel groove 12.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

### REFERENCE TO THE NUMERALS

1. Pipe Support base
2. Pipe Fastner
3. Body
12. Channel Groove
13. Engagement member
13a. Engagement Sleeve
21 Hook
P Pipe P

What we claim is:

1. A pipe support base, comprising:
a solid body;
at least one channel groove formed on one of four side longitudinal surfaces of said solid body; and
an engagement member fitting over a surface of said channel groove and designed to function as a rail for a pipe fastener to slide along said channel groove.

2. The pipe support base according to claim 1, wherein
said solid body is made of concrete.

3. The pipe support according to claim 1, wherein
said solid body is made of plastic material.

4. The pipe support according to claim 1, wherein
said engagement member is made of a metal plate deformed to fit over the surface of the channel groove.

5. The pipe support according to claim 1, wherein
width of said engagement member is adjustable for different types of pipe fasteners.

6. The pipe support according to claim 1, wherein
said engagement member is made of plastic material.

7. The pipe support according to claim 1, wherein
said channel groove functions as said engagement member.
